(19) United States
(12) Patent Application Publication
(10) Pub. No.: US 2015/0113905 A1
(43) Pub. Date: Apr. 30, 2015

(54) FIXING CLIP

(71) Applicant: Adam Robert WATSON, Victoria (AU)

(72) Inventor: Adam Robert WATSON, Victoria (AU)

(21) Appl. No.: 14/528,260

(22) Filed: Oct. 30, 2014

Related U.S. Application Data
(60) Provisional application No. 61/898,010, filed on Oct. 31, 2013.

(51) Int. Cl. E04B 1/38; E04F 13/23; F16B 5/00; E04F 13/25

(52) U.S. Cl. CPC E04B 1/38; E04F 13/25; E04F 13/23; F16B 5/0004
USPC 52/698

(57) ABSTRACT

A fixing clip for mounting a furring channel onto a support structure. A connection portion is used to attach the fixing clip to a furring channel and has a connection arrangement which defines a furring channel receiving gap therein through which the furring channel passes in fixing clip use. The connection arrangement is moveable between at least two different positions relative to a base portion to position the connection arrangement at different distances from the base portion and extending across the furring channel receiving gap. A locking arrangement extends between the base portion and the connection portion and is used to secure the connection arrangement of the connection portion at a selected position relative to the base portion.

### TECHNICAL FIELD

This invention relates generally to mounting of articles onto support structures and, in particular, to fixing clips for mounting elongate members onto the surface of a support structure. The fixing clip is applicable to mounting furring members, such as sheet metal furring channels, onto existing building wall or ceiling structures in order to provide a furring support framework for new wall or ceiling cladding. It will be convenient to hereinafter describe the invention in relation to that exemplary application, although it should be appreciated that the invention is not limited thereto.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Internal walls and ceiling structures of buildings are sometimes refurbished by applying a new wall or ceiling cladding over the existing surface. That cladding, which for example may be plasterboard, is usually secured in position overlying the existing wall or ceiling surface by means of a support framework of elongate furring members mounted on to the existing wall or ceiling surface. The framework includes an array of furring members arranged in parallel, spaced apart relation over the existing surface. The new cladding then overlies the framework, and is attached thereto in order to secure the cladding in position. Securing of the new cladding to the framework may be achieved, for example, by means of adhesive, or fasteners such as screws and nails.

The furring members may be mounted to the existing wall or ceiling by fasteners such as bolts, screws or nails, positioned in spaced apart relation along the member. Alternatively, various arrangements of metal furring channels and fixing clips have been developed for that purpose. Those fixing clips are attached on to the existing wall or ceiling with fasteners in spaced apart relation along a line on which the furring channel is to be located. The channel is then positioned over those fixing clips, and snap connected thereto in order to mount the channel on to the wall or ceiling.

One such fixing clip is described in the applicant's U.S. Pat. No. 5,720,460. This fixing clip includes a base plate through which the fixing clip is attached to the support structure and a connection section onto which a furring channel can attach. The base plate has a pair of plate sections arranged so that the base plate is generally T-shaped, each plate section providing a respective bearing surface region positioned for individual face-to-face bearing on a surface of the support structure. Each plate section has a centrally located fastening hole. Each connection section includes a pair of connection arms which extend from the base plate so as to outstand from the support structure when the fixing clip is attached thereto. Each connection arm includes a series of complementary connection recesses which are paired so as to define a series of furring channel receiving slots therebetween through which the furring channel is received in fixing clip use. The fixing clip recesses are spaced apart along each connection arm at different distances from the base portion and facing across a furring channel receiving gap.

The spaced apart fixing clipping recesses provide adjustability to the distance the furring channel is connected relative to the base plate and thus the support structure. However, the degree and size of this adjustment is limited by the physical size, spacing and configuration of the fixing clipping recesses. Finer adjustment of distances from the base portion and facing across the furring channel receiving gap is not possible.

It is therefore desirable to provide an alternative and/or improved fixing clip for furring members.

### SUMMARY OF THE INVENTION

According to one aspect of the present invention there is provided a fixing clip for mounting a furring channel onto a support structure, including:

a base portion through which the fixing clip can be attached to the support structure;

a connection portion through which the fixing clip is attachable to the furring channel, the connection portion being located in a position relative the base portion which outstands from the support structure when the fixing clip is attached thereto, the connection portion having a connection arrangement which defines a furring channel receiving gap therein through which the furring channel passes in fixing clip use, the connection arrangement being moveable between at least two different positions relative to the base portion to position the connection arrangement at different distances from the base portion and extending across the furring channel receiving gap; and

a locking arrangement extending between the base portion and the connection portion, the locking arrangement securing the connection arrangement of the connection portion at a selected position relative to the base portion,

whereby, in fixing clip use, a furring channel passes through the furring channel receiving gap and a pair of outwardly projecting flanges of the furring channel are receivingly engaged in the connection arrangement, the connection arrangement being located in the desired position relative to the base portion and secured in that position using the locking arrangement, thereby locating the furring channel at a predetermined distance from the support structure.

The fixing clip of the present invention includes a single connection arrangement which is moveable and securable at two or more positions outstanding from the base portion using a locking arrangement. The degree of adjustability can therefore be designed in relation to the configuration of the locking arrangement rather than the physical dimensions and/or configuration of the fixing clip recess. This configuration therefore can be configured to provide finer adjustment of the position of the connection arrangement relative to the base portion as compared to prior fixing clip arrangements and thus enable a user to more accurately position and level a furring channel for mounting cladding thereto.

The locking arrangement can comprise any suitable cooperative assembly or device which secures the connection arrangement at a selected position outstanding from the base portion of the fixing clip. In some embodiments, the locking arrangement comprises at least one locking portion extending from the base portion, preferably outstanding from the support structure when the fixing clip is attached thereto. The locking portion and connection portion include cooperating engagement portions which, in use, can be cooperatively engaged to secure the connection arrangement of the connection portion at a selected position relative to the base portion. The locking portion is preferably positioned proximate to the connection portion. The proximate locations facilitate inter-engagement of the connection portion and locking portion. In some embodiments, the locking arrangement comprises a pair of locking portions extending from the base portion and positioned in spaced apart relation about the connection portion. In this form, the locking portions preferably comprise side members which extend in substantially parallel spaced apart planes outwardly and substantially perpendicular to the base portion. The side members can have any suitable configuration including rods, sheets, plates, mesh or similar. In one embodiment, the side members comprise side plates.

It is preferred that each side member is flexible, more preferably resiliently flexible to enable the side member to be moved to receive the connection portion and cooperating engagement portions thereof, and then cooperatively engage with the connection portion to secure the connection arrangement in the selected position. Each side member is therefore preferably biased, more preferably resiliently biased, towards engagement with the connection portion. Moreover, each side member can also includes at least one cut out or opening proximate a connection region between the side member and the base plate. The cut out or opening is designed to reduce the amount of material at the connection and therefore provide extra flexibility in movement of the side member about the connection region.

The cooperating engagement portions of the connection portion and the locking portions can have any suitable configuration. Suitable configurations include hooks, apertures, slots, rods, tabs, or fasteners such as bolts, pins, rivets, fixing clips or the like. In a preferred embodiment, the cooperating engagement portions of the connection portion and the locking portions comprise a cooperative tab and aperture arrangement. Each locking portion preferably includes a series of spaced apart apertures set at different positions outstanding from the base plate configured to receive a cooperating tab located on the connection portion. In other embodiments, the aperture arrangement may comprise one or more apertures having one or more recesses or flanges configured to capture a tab. This enables a user to select the most appropriate position for the connection arrangement relative to the support structure, and thereby adjust the distance the connected furring channel outstands from the support structure. Each tab can be configured to be bent or otherwise deformed once received in a selected cooperating aperture in the locking portion.

The connection portion can have any suitable configuration. In some embodiments, the connection portion extends from and outstands from the base portion. The connection portion is therefore preferably connected to the base portion. This connection can comprise a single member, or a number of connection portions. In one embodiment, the connection portion comprises a sheet or plate shaped member. In another embodiment, the connection portion comprises a T-shaped member having a single elongate leg member which extends from the base portion and a cross-member connected across the distal end of the leg member in which the connection arrangement is located. In another embodiment, the connection portion comprises an inverted U-shaped member having two elongate leg members which extend from the base portion and a cross-member connected between each leg member in which the connection arrangement is located. Like the side members, the connection portion can include at least one cut out or opening proximate a connection region between the connection portion and the base plate to provide flexibility, and/or resilience.

The adjustable height of the connection arrangement relative to the base portion is provided by the movability of the connection portion. The connection arrangement is preferably movable between at least a first position in which the connection arrangement is outstanding from the base portion by a first distance and at least a second position in which the connection arrangement is outstanding from the base portion by a second distance. Further positions (three, four or more) can be provided in which the connection arrangement is outstanding from the base portion by a further distances. It is preferred that the connection arrangement is movable between multiple positions.

The connection portion can be configured to be movable relative to the base plate about a movement line or axis, preferably a hinge line, located between the connection portion and the base plate to facilitate movement of the connection arrangement. This movement can be facilitated by at least one of pivoting, bending, or deformation of the connection about the hinge line. It should be appreciated that other movements are also possible including translational, sliding, rotating or the like.

In some embodiments, the connector portion comprises a separate but attachable element to the fixing clip. In these embodiments, the connector portion comprises an element which includes at least one connection arrangement and cooperating engagement portions for engagement with the locking portion. The connector portion is therefore manually movable relative to the base portion and is secured into position at a selected position outstanding the base position using the cooperating engagement portion.

The base portion is used to attach the fixing clip to the support structure. The base portion therefore has at least one fastening fixture such as a slot, aperture or a through hole, through which a fastener can be received or attached to fasten the fixing clip to the support structure. In some embodiments, the base portion includes at least one fastening extension for fastening the fixing clip to the support structure, each fastening extension extending from the base portion so as to outstand from the connected assembly of the furring channel and connection portion. The fastening extensions allow the fixing clip to be attached to the support structure with the furring channel connected to the connection portion.

The fastening extension is typically a section of the base portion which has been designed to be accessible to a user when a furring channel is connected to the connection portion. In one embodiment, the at least one fastening extension is a plate section which extends substantially perpendicularly relative to the connection portion to outstand from the connected assembly of the furring channel and connection portion. The plate section can be a separate section which is attached to a main body forming the base portion or an integral section of a body forming the base portion.

The base portion can have any suitable form which can be mounted against a support structure. In one preferred form the base portion is provided by a rigid base plate having a surface providing at least one bearing surface region for individual face-to-face bearing on a surface of the support structure. In this embodiment, the at least one fastening extension is preferably formed from a plate section of the base plate, each plate section being arranged in side-by-side relation with other sections of the base plate. It is also preferable in some forms for the plate sections to be relatively arranged so that the base plate is a generally elongate rectangular plate with at least one fastening extension arranged at a longitudinal end thereof.

The fixing clip can be fastened to the support structure at one or more locations. As can be appreciated, the fastening section may not in some cases be located near or at the center of the fixing clip. Accordingly, it may be desirable to include two or more fastening locations in the fixing clip. In some embodiments, the fixing clip therefore includes at least two spaced apart fastening extensions. The fixing clip can therefore be secured to the support structure using one or more of these fastening extensions.

The fastening extension preferably includes some form or means of fastening the base portion to the support structure. Accordingly, it is preferable for the at least one fastening extension to also include a fastening fixture, such as a slot, aperture or through hole, through which a fastener can be received or attached to fasten the fixing clip to the support structure. A fastener such as for example a screw, rivet, or nail can be received through the hole and secured within the support structure to fasten the fixing clip to the support structure.

The base portion preferably has a bearing surface for face-to-face bearing on a surface of the support structure. Preferably, a rigid base plate provides the base portion, that base plate having a surface forming the bearing surface.

The connection arrangement preferably includes a pair of connection regions. Those regions outstand from the base portion and provide the connecting positions. Thus, the connection regions preferably engagingly connect with respective flanges of the furring channel in order to connect the channel to the fixing clip. Preferably, the connection regions are spaced apart so as to define a furring channel receiving gap therebetween. In fixing clip use, the furring channel passes through the receiving gap, and the connection regions extend to opposite outsides of the channel and engage with outwardly projecting flanges of the channel at a selected one of the connecting positions.

The connection arrangement is preferably configured for fixing clip connecting the furring channel to the connection regions. The connection arrangement preferably includes a pair of spaced apart fixing clipping recesses positioned to receive a respective furring channel flange therein in order to connect the furring channel to the fixing clip. The fixing clipping recesses preferably extend perpendicularly to the furring channel receiving gap. More preferably, the fixing clipping recesses are elongate and open at one end into the furring channel receiving gap to receive a respective furring channel flange therein, the recesses each have a longitudinal axis extending in a direction perpendicular to the furring channel receiving gap.

In some embodiments, the fixing clipping recesses comprise a fixing clipping slot having an end opening into the furring channel receiving gap through which a respective furring channel flange is receivable, the end having a restricted opening into the slot in order to inhibit flange removal therefrom.

According to yet another aspect of the present invention, there is provided a method of fastening a fixing clip to a support structure, including the steps of:

connecting two or more fixing clips according to the present invention at spaced apart locations along the length of a furring channel;

arranging the fixing clips and furring channel in a desired location and configuration on a support structure; and

fastening the fixing clips to the support structure using the fastening extensions.

### BRIEF DESCRIPTION OF THE DRAWINGS

The present invention will now be described with reference to the figures of the accompanying drawings, which illustrate particular preferred embodiments of the present invention, wherein:

FIG. 1A is a front perspective view of a fixing clip according to a first embodiment of the present invention;

FIG. 1B is a back perspective view of a fixing clip according to a first embodiment of the present invention;

FIG. 2A is a further front perspective view of a fixing clip according to a first embodiment of the present invention showing use of a locking arrangement of the fixing clip;

FIG. 2B is a further back perspective view of a fixing clip according to a first embodiment of the present invention showing use of a locking arrangement of the fixing clip;

FIG. 3 is a front perspective view of an fixing clip according to a second embodiment of the present invention;

FIG. 4 is a rear perspective view of the fixing clip of FIG. 1 with a furring channel connected thereto; and

FIG. 5 is a cross sectional view of the fixing clip and furring channel through section III-III of FIG. 4 and showing the fixing clip in one orientation mounting the furring channel to a support structure.

### DETAILED DESCRIPTION

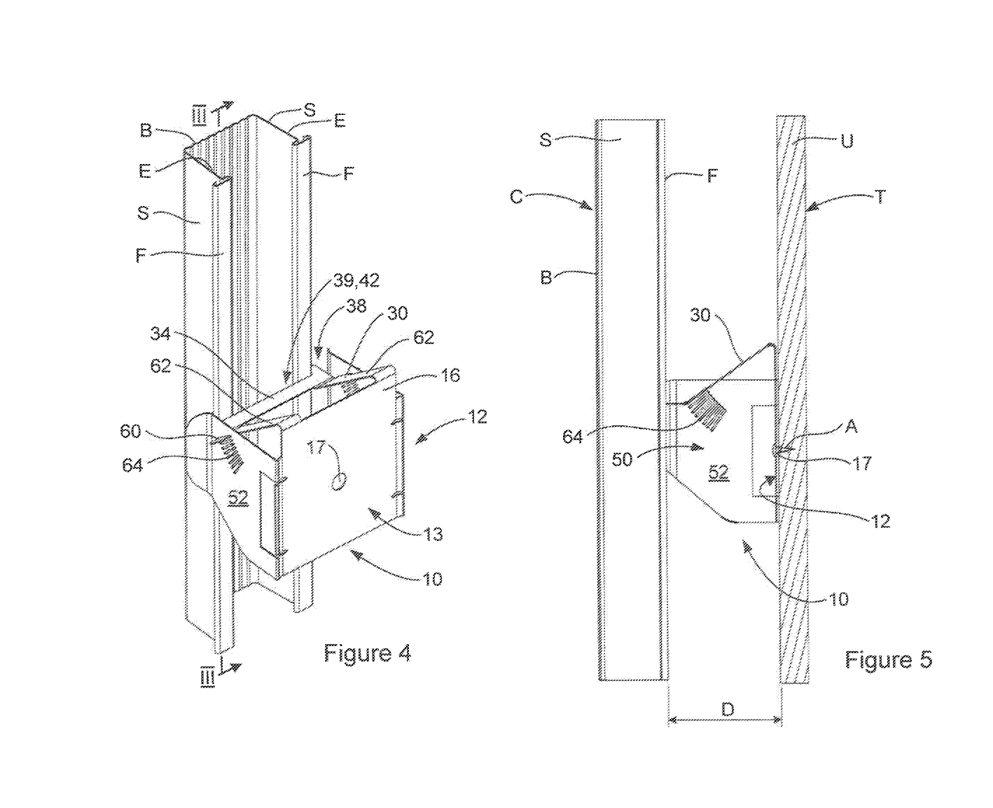

Referring to the drawings there is generally shown a fixing clip 10 used in mounting an elongate furring channel C (FIGS. 4 and 5) onto a support structure T (FIG. 5), such as an existing wall or ceiling structure.

The furring channel C shown in FIGS. 4 and 5 is particularly suitable for use with the fixing clip 10. The furring channel C is composed of sheet metal and is of generally square U-shaped cross-sectional profile. The channel C is of one piece construction, and has a bottom wall B and a pair of side walls S outstanding therefrom. In use, the channel C will be orientated so that the side walls S form spacing strips extending out from the surface U of the support structure T, while the bottom wall B provides a fastening strip spaced from the surface U and to which cladding (not shown) can be secured, as will be described in more detail hereinafter.

This furring channel C also has a pair of elongate flanges F extending along respective side walls S and projecting laterally therefrom. With one particularly suitable furring channel C (as shown), the flanges F extend along free edges E of the side walls S remote from the bottom wall B, and project at least outwardly therefrom. The flanges F may also project inwardly, on one particular channel C (not shown). Those flanges F are co-planar, and extend parallel with the plane of the bottom wall B, in this particular channel C.

It will be convenient to hereinafter further describe the fixing clip 10 with reference to this particular furring channel C. However, as will be appreciated by those skilled in this art, the fixing clip 10 is not limited to use with such a channel C, and that other furring channels or similar members may be equally suited for use with the fixing clip 10 of the present invention.

The illustrated fixing clip 10 comprises three main sections:
a base portion 12 through which the fixing clip 10 can be attached to a support structure T;
a connection portion 30 through which the fixing clip 10 is attachable to the furring channel C; and
a locking arrangement 50 which extends between the base portion 13 and the connection portion 30, and is configured to secure a connection arrangement 38 of the connection portion 30 at a selected position relative to the base portion 12.

Each of the sections 12, 30, 50 will now be described in detail in turn:

Firstly, the illustrated base portion 12 is of generally planar configuration and, in use, is positioned between the support structure surface U and the furring channel C (FIG. 5). Thus, the furring channel C will generally overlie the base portion 12 during use of the fixing clip 10. The base portion 12 provides a generally flat bearing surface 13 for face-to-face bearing on the surface U of the support structure T (FIG. 5), when the base portion 12 is attached thereto, as shown in FIG. 4. The base portion 12 is provided by a rigid base plate 14. The base plate 14 is a generally square or rectangular primary plate having a pair of side edges 19 and a pair of end edges 20. That plate 14 also has opposed surfaces 15, 16, of which the base surface 16 forms the bearing surface 13.

The base portion 12 can be attached to the support structure T in any suitable manner. In this embodiment, that attachment is achieved with fasteners A, such as bolts, screws or nails secured through at least one attachment aperture or hole 17 in the base portion 12. In the illustrated embodiments, the base plate 14 is provided with a central fastening hole 17.

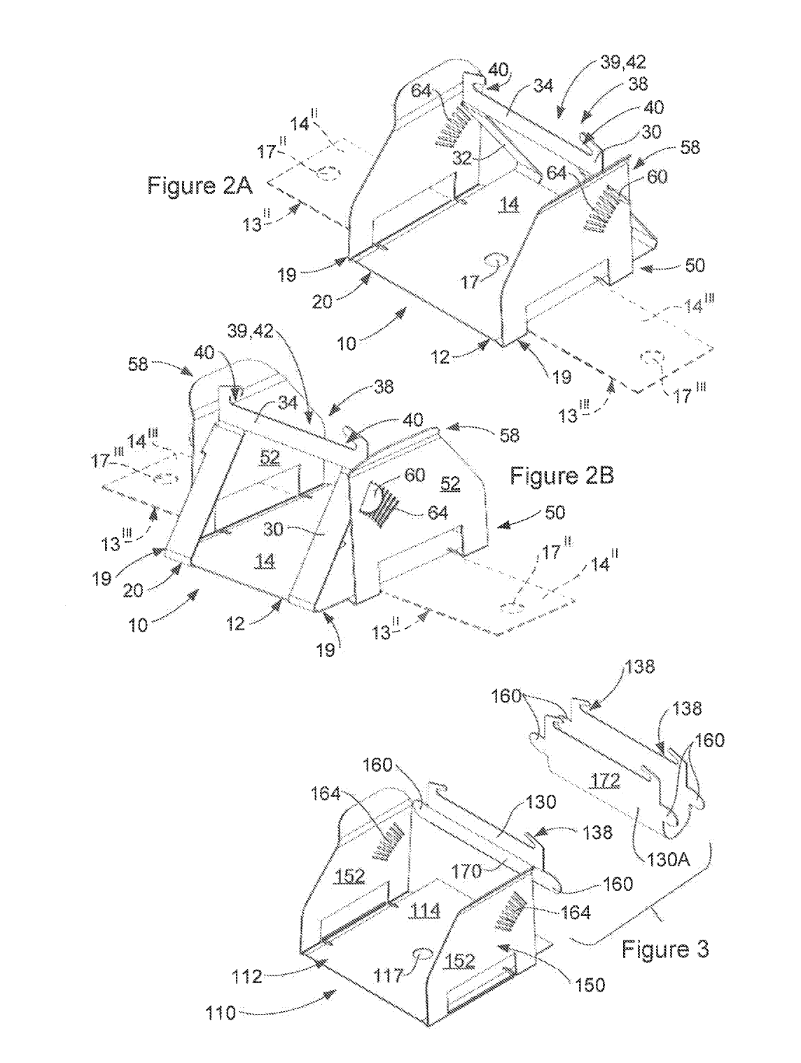

In some embodiments, the base portion 12 can further include auxiliary or fastening plate sections 14″ and 14″ (shown in broken lines in FIGS. 2A and 2B) which form fastening extension sections which extend outwardly from the side edges 19 of the base plate 14. Fastening plate sections 14″ provide further bearing surfaces 13″ and 13″ and fastening positions for attaching the fixing clip 10 to the support structure T. Each plate section 14″ and 14′ also includes a central fastening hole 17″, being a through hole, which can receive a fastener, and can be used, where desired to mount individual fixing clips 10 to a support structure T.

Each of the plate sections of the base portion 12 provide a co-planar bearing regions 13, 13, 13″ respectively which are relatively positioned along the length of the base portion 12 corresponding to the different sections which can be fastened to and abut a support surface when the fixing clip 10 is fastened to the support surface U of structure T.

The base plate 14 is sized relative to the furring channel C so that, in use, the base plate 14 is substantially confined between the side walls S and flanges F of the channel C and is obscured by the furring channel C. Where provided, each of the fastening plate sections 14″ and 14″ projects longitudinally outwardly beyond the side walls S and flanges F of the channel C. With this arrangement, when the central base plate 14 is in face-to-face relation with the support structure T, the secondary plate sections 14″ and 14″ project outwardly and away from the side walls S into the furring channel C. In this way, a fastener A can be passed through that fastening hole 17″ in the fastening plate section 14″ and/or 14″ when the furring channel C is connected to the connection section 30 of the fixing clip 10, and allow the user to attached the fixing clip 10 to the support structure T, as shown in FIGS. 3 and 4.

The fixing clip 10 also includes a connection portion 30 through which the fixing clip 10 is attachable to the furring channel F. The illustrated connection portion 30 extends from the base portion 12 so as to outstand from the central base plate 14 when the fixing clip 10 is attached thereto. As shown in FIGS. 4 and 5, the furring channel C is connectable to the connection portion 30 in order to mount the channel C to the structure T.

The illustrated connection portion 30 comprises an inverted U-shaped connector plate having two elongate leg members 32 which extend from the base plate 14 and an upper cross-member 34 connected between each leg member 32. The U-shape of the connection portion 30 reduces the amount of material proximate a connection region between the connection portion 30 and the base plate 14 to provide flexibility/resilience in the leg members 32 to facilitate movement thereof (as described below). Whilst the illustrated embodiment of the connector portion 30 has an inverted U-shape, it should be appreciated that other shapes and configurations are possible, including T-shapes, C-shapes, V-shapes, triangular shapes or the like.

The top side 36 of the upper cross-member 34 of the connector portion 30 includes a connection arrangement 38 which defines a furring channel receiving gap 39 therein through which the furring channel F passes in fixing clip use. In the illustrated embodiment, the connection arrangement 38 comprises a pair of fixing clipping recesses 40 which cooperate with respective flanges F of the furring channel C to achieve connection. The fixing clipping recesses 40 form a fixing clipping slot 42 formed in the cross-member 34 of the connection portion 30 facing across the furring channel receiving gap 39. The fixing clipping slot 42 is shaped and sized so that the furring channel flanges F are interferingly engaged therein in order to firmly secure the channel C. In this embodiment, the slot 42 is of a shape and size that requires the side walls S of the furring channel C to be resiliently deflected inwardly toward one another in order to position the channel C in the receiving gap 39 and locate the flanges F in the fixing clipping slot 42. Upon release, the deflected side walls S resiliently return outwardly, causing the flanges F to move into that slot 42. However, the shape and size of that slot 42 is such that the flanges F interferingly engage against end faces 48 of the slot 42, with some deflection return force remaining in the side walls S. In this embodiment, the side walls S of the channel C are manually deflectable, release of the deflected side walls S tending to cause the flanges F to snap return into the fixing clipping slot 42.

The fixing clipping slot 42 is generally rectangular in shape (as shown). However, other shapes are contemplated and, in particular, the end face 48 of the slot 42 may be curved or otherwise profiled to correspond with the channel flange F shape so that the engaging flanges F are neatly received thereagainst. Moreover, in one embodiment (not shown), the slots 42 may be shaped so as to provide a narrowed or restricted opening in order to inhibit accidental flange F removal therefrom.

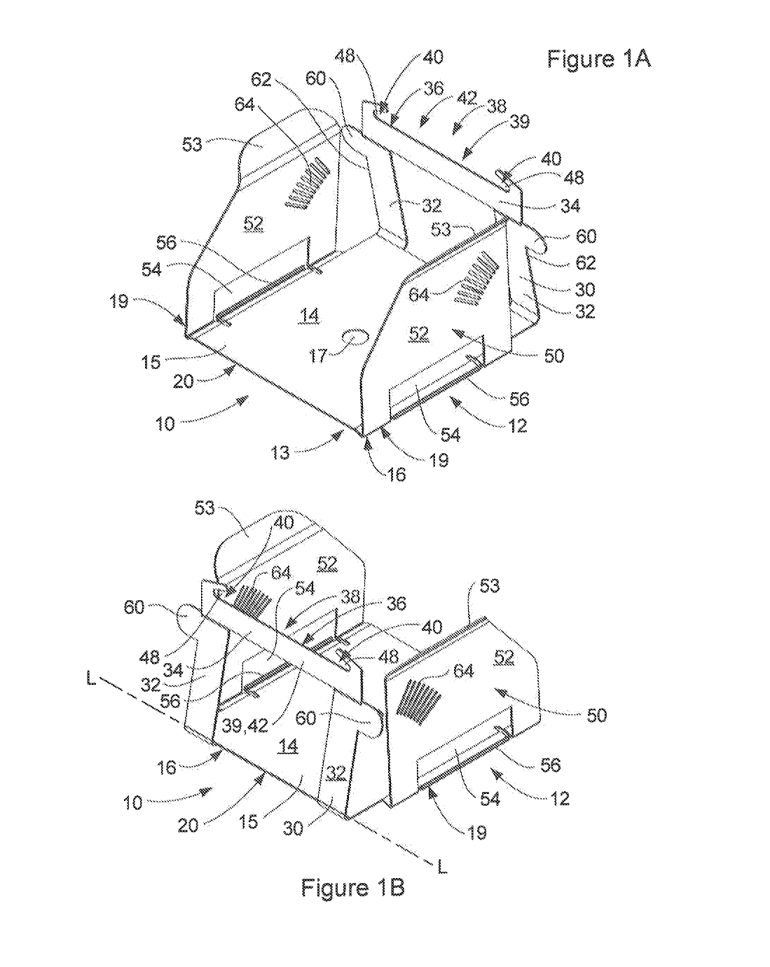

The connection arrangement 38 is designed to be moveable between at least two different, preferably multiple, positions relative to the base portion 12 to position the connection arrangement 38 at different distances from the base portion 12 and facing across the furring channel receiving gap F. The adjustable height of the connection arrangement relative to the base portion is provided by the movability of the connection portion. This movement is facilitated by bending or otherwise deforming the legs 32 of the connection portion 30 relative to the base plate 14. As shown in FIGS. 1 and 2, the connector portion 30 can be bent or otherwise deformed relative to the base plate 14 about a hinge line L-L (FIG. 2). Whilst movement of connector portion 30 in the illustrated embodiment involves bending or deformation, it should be appreciated that other movements are also possible including translational, sliding, rotating or the like could equally be used to achieve the same outcome.

The position of the connection arrangement 38 relative to the base portion 12 is secured in a selected position using the locking arrangement 50. The illustrated locking arrangement 50 comprises a pair of locking plates 52 which extending from the side edges 19 of the base plate 14 so as to outstand from the support structure T when the fixing clip 10 is attached thereto. The locking plates 52 are spaced apart about the connection portion 30 and extend in substantially parallel spaced apart planes outwardly and substantially perpendicular to the base plate 14. The locking plates 52 are also sized and positioned relative to the furring channel C so that, in use, each are spaced around and substantially apart from the side walls S and flanges F of the furring channel C.

Each locking plate 52 is flexible, preferably resiliently flexible, to enable the side member to be moved to receive and cooperatively engage with the connection portion 30 to secure the connection arrangement in the selected position. Each locking plate 52 is therefore preferably biased towards engagement with the connection portion 30. Each locking plate 52 includes an inclined top portion 53 designed to assist manual manipulation of the locking plates 52.

Each locking plate 52 includes a cut out or opening 54 designed to reduce the amount of material at the connection region 56 between the locking plate 52 and base plate 14 and therefore provide extra flexibility in movement of the locking plate 52 about that connection region 56.

Engagement and securement between the locking plates 52 and connection portion 30 is achieved using cooperative engagement arrangement 58 (FIGS. 2A and 2B) on the connection portion 30 and the locking plates 52. In the illustrated arrangement, the cooperative engagement arrangement 58 comprises a pair of connector tabs 60 located on the side edges 62 of the connector portion 30 proximate the connection arrangement 38 and a complementary series of spaced apart locking slots 64 located in the sides of the locking plates 52. The locking slots 64 are preferably dimensioned to have a greater width than the width of the connector tabs 60.

It should also be appreciated that the cooperative engagement arrangement 58 can have any suitable interlocking configuration provided by one or more of hooks, apertures, slots, rods, tabs, or fasteners such as bolts, pins, rivets, fixing clips or the like and achieve the same locking function. Moreover, it should be appreciated that in some embodiments (not illustrated) the locking slots 64 could be formed in a single aperture having one or more recesses or flanges configured to capture a cooperative connector tab 60.

The locking slots 64 in each locking plate 52 are set at different positions outstanding from the base plate 14 to enables a user to select the most appropriate position for the connection arrangement 38 relative to the support structure T, and thereby adjust the distance the connected furring channel F outstands from the support structure T. In the illustrated embodiment, the locking slots 64 are spaced 1 mm apart. The illustrated arrangement enables a 20 mm total movement in 2 mm increments. It should be appreciated that this spacing and total movement can be designed to comprise any suitable distance. Each connector tab 60 is preferably configured to be bent or otherwise deformed once received in a selected cooperating locking slot 64. The slots 64 are spaced in an arc equivalent to the rotation of the connector portion 30 and attached connector tabs 60.

In use, the connection portion 30 is set to a selected position by bending or the locking plates 52 outwardly away from connector portion 30 to free the connector tabs 60 from the locking slots 64 that the connector tabs 64 may currently extend through. The connector portion 30 is moved (preferably bent or otherwise deformed) to the selected position relative to the base plate 14. The locking plates 52 can then be released to enable the connector tabs 60 be received through the locking slots 64 corresponding to that position (as best shown in FIGS. 2A and 2B). In some embodiments, the ends of the connector tabs 60 can then be bent to secure the tabs 60 in that position.

FIG. 3 illustrates a second embodiment of a fixing clip 110 according to the present invention. The fixing clip 110 has substantially the same configuration as the fixing clip 10 described in relation to FIGS. 1A to 2B. In this respect, the base portion 112 and locking plates 152 and connection arrangement 138 have the same configuration and function as the base portion 12 and locking plates 52 and connection arrangement 38 of the embodiment shown in FIGS. 1A to 2B. It should be appreciated that the above description equally applies to this embodiment. However, in this embodiment, the connector portion 130 and 130A comprise a separate but attachable element to the base portion 112 and locking plates 152 of the fixing clip 110. Two embodiments of the connector portion 130 and 130A are illustrated. The first embodiment of the connector portion 130 comprises a single connection arrangement 138 attached to base section 170 in which the connector tabs 160 are attached. The connector tabs 160 are received in selected cooperating locking slots 164 to mount the connector portion at a selected location outstanding the base portion 112. The second embodiment of the connector portion 130A includes two spaced apart connection arrangements 138 interconnected by a curved base section 172 in which the two sets of connector tabs 160 are attached. The two sets of connector tabs 160 are designed to be received in selected adjacent locking slots 164 in the locking plates 152 to mount the connector portion at a selected location outstanding the base portion 112. The use of two sets of locking tabs 160 provides a more secure and stable engagement between the locking plates 152 and connector portion 130A. As can be appreciated, the respective connector portion 130 and 130A is manually movable relative to the base portion 112 and is secured at a selected position outstanding the base position 112 by interengagement of the respective locking tabs 160 into the appropriate locking slots 164.

The fixing clip 10, 110 is constructed in any suitable manner from any appropriate material, having regard to its intended application. In this embodiment of the fixing clip 10, 110 intended for the exemplary application, the fixing clip 10, 110 is formed from sheet metal, such as galvanised steel sheet, more preferably spring steel, and even more preferably hardened spring steel. The fixing clip 10, 110 can be stamped, cut and folded into shape as necessary.

Use of a fixing clip 10 will now be outlined according to this preferred embodiment of the present invention, in mounting a furring channel C on to an existing support wall surface U.

Furring channels C are attached to an existing wall surface U in an array so as to form a furring channel framework (not shown) for supporting a new wall cladding (not shown). Typically, the channels C are mounted vertically on the existing wall surface U at about 600 mm centre-to-centre spacing. The fixing clips 10 used to so mount the channels C are attached along channel lines at about 1200 mm spacing.

Each fixing clip 10 in turn is attached to the existing wall surface U in alignment with the furring channel C. This can be achieved by either mounting a series of aligned fixing clips 10 to the existing wall surface U and then mounting the furring channel C to those fixing clips 10 or alternatively attaching a series of fixing clips 10 to the furring channel C and then mounting those fixing clips 10 to the existing wall surface U.

Where each fixing clip 10 is first attached to the existing wall surface U, each fixing clip 10 is manually placed in position on a channel line and adjacent a plumb line lying on or parallel to a plane proposed to contain the bottom wall B of the furring channels C. The positioned fixing clip 10 is then fastened with fasteners A, such as bolts or nails, passing through an attachment hole 17 in the base plate 14. With a line of fixing clips 10 attached to the existing wall surface U, a furring channel C can then be connected to those fixing clips 10 as described below. The connector section 30 of each fixing clip 10 can either be locked in a preselected position relative to the base plate 14 and locking plates 52 using the locking arrangement 50 of each fixing clip 10, or left unattached (such as is shown in FIG. 1) awaiting an adjustment action (described below).

Where each fixing clips 10 is first attached to the furring channel C, each fixing clip 10 is prearranged into its desired position and spacing along the length of the furring channel C. The furring channel C and secured fixing clips 10 are then placed in position with bearing surface 13 of each fixing clip 10 abutting the support surface U. Each fixing clip 10 is orientated along the proposed position of the respective furring channel C. The connector section 30 of each fixing clip 10 is locked in a preselected position relative to the base plate 14 and locking plates 52 using the locking arrangement 50 of each fixing clip 10.

Each fixing clip 10 can be mounted on the furring channel C by manually squeezing the channel C so as to deflect the side walls S inwardly toward one another, allowing the channel C to enter the gap 39 in the connection arrangement 38. The channel C is maneuvered within that gap 39 until the channel flanges F align with the fixing clipping slots 42. In that location, the channel side walls S are released, allowing them to return deflect, and the flanges F to snap into those slots 42 for interfering engagement therewith. With each fixing clip 10 manually held in its respective position along the length of the furring channel C, each fixing clip 10 can be fastened into position on the wall surface U using fasteners A, such as bolts or nails, passing through an attachment hole 17″ in the fastening plate sections 14″ and/or 14′″ either side of the furring channel C on the wall surface U.

With a line of fixing clips 10 attached to the existing wall surface U, the furring channel C can then be adjusted so that the bottom wall B of the furring channel C provides a uniform and planar surface on which cladding or the like can be mounted. In this respect, the connection portion 30 of each fixing clip 10 can be manually moved to a selected adjustment position which needs to be adjusted by bending or the locking plates 52 outwardly away from connector portion 30 to free the connector tabs 60 from the current locking slots 64, then manually moving the connector portion 30 to the selected position relative to the base plate 14 and then releasing the locking plates 52 (which resiliently return to their original position) to enable the connector tabs 60 be received through the locking slots 64 corresponding to that position. Connection of the channel C to each fixing clip 10 firmly and positively mounts the channel C on to the wall in a position at which the bottom wall B lies on the desired framework plane.

Each line of fixing clips 10 is similarly attached to the existing wall surface U, and furring channels C adjusted within those fixing clips 10, in order to complete the furring channel framework.

The fixing clip 10, 110 of the present invention enables easy yet accurate mounting of furring members on to the surface of support structures. That can be achieved without a high degree of skill on the part of the installer. The fixing clip 10, 110 of the present invention is of simple construction and, accordingly, of low capital cost.

Those skilled in the art will appreciate that the invention described herein is susceptible to variations and modifications other than those specifically described. It is understood that the invention includes all such variations and modifications which fall within the spirit and scope of the present invention.

1. A fixing clip for mounting a furring channel onto a support structure, including:
a base portion through which the fixing clip can be attached to the support structure;
a connection portion through which the fixing clip is attachable to the furring channel, the connection portion being located in a position relative the base portion which outstands from the support structure when the fixing clip is attached thereto, the connection portion having a connect ion arrangement which defines a furring channel receiving gap therein through which the furring channel passes in fixing clip use, the connection arrangement being moveable between at least two different positions relative to the base portion to position the connection arrangement at different distances from the base portion and extending across the furring channel receiving gap; and
a locking arrangement extending between the base portion and the connection portion, the locking arrangement securing the connection arrangement of the connection portion at a selected position relative to the base portion,
whereby, in fixing clip use, a furring channel passes through the furring channel receiving gap and a pair of outwardly projecting flanges of the furring channel are receivingly engaged in the connection arrangement, the connection arrangement being located in the desired position relative to the base portion and secured in that position using the locking arrangement, thereby locating the furring channel at a predetermined distance from the support structure.

2. The fixing clip according to claim 1, wherein the locking arrangement comprises at least one locking portion extending from the base portion, the locking portion and connection portion including cooperating engagement portions which, in use, can be cooperatively engaged to secure the connection arrangement of the connection portion at a selected position relative to the base portion.

3. The fixing clip according to claim 2, wherein the locking portion is positioned proximate to the connection portion.

4. The fixing clip according to claim 2, wherein the locking arrangement comprising a pair of locking portions extending from the base portion and positioned in spaced apart relation about the connection portion.

5. The fixing clip according to claim 2, wherein the locking portions comprise side members which extend in substantially parallel spaced apart planes outwardly and substantially perpendicular to the base portion.

6. The fixing clip according to claim 5, wherein each side member includes at least one cut out or opening proximate a connection region between the side member and the base plate.

7. The fixing clip according to claim 5, wherein each side member is biased, preferably resiliently biased, towards engagement with the connection portion.

8. The fixing clip according to claim 2, wherein the cooperating engagement portions of the connection portion and the locking portions comprise a cooperative tab and aperture arrangement.

9. The fixing clip according to claim 8, wherein each locking portion includes a series of spaced apart apertures set at different positions outstanding from the base plate configured to receive a cooperating tab located on the connection portion.

10. The fixing clip according to claim 9, wherein each tab is configured to be bent or otherwise deformed once received in a selected cooperating aperture in the locking portion.

11. The fixing clip according to claim 1, wherein the connection portion extends from and outstands from the base portion.

12. The fixing clip according to claim 1, wherein the connection portion includes at least one cut out or opening proximate a connection region between the connection portion and the base plate.

13. The fixing clip according to claim 1, wherein the connection portion comprises an inverted U-shaped member having two elongate leg members which extend from the base portion and a cross-member connected between each leg member in which the connection arrangement is located.

14. The fixing clip according to claim 1, wherein the connection arrangement is movable between at least a first position in which the connection arrangement is outstanding from the base portion by a first distance and at least a second position in which the connection arrangement is outstanding from the base portion by a second distance.

15. The fixing clip according to claim 1, wherein the connection portion is movable relative to the base plate about a hinge line located between the connection portion and the base plate to facilitate movement of the connection arrangement.

16. The fixing clip according to claim 15, wherein the connection portion is movable by at least one of pivot, bending, or deforming about the hinge line.

17. The fixing clip according to claim 1 including a rigid base plate providing the base portion, the base plate having a surface providing at least one bearing surface region for individual face-to-face bearing on a surface of the support structure.

18. The fixing clip according to claim 1, wherein the base portion includes at least one fastening extension for fastening the fixing clip to the support structure, each fastening extension extending from the base portion so as to outstand from the connected assembly of the furring channel and connection portion.

19. The fixing clip according to claim 18, wherein the at least one fastening extension is a plate section which extends substantially perpendicularly relative to the connection portion to outstand from the connected assembly of the furring channel and connection portion.

20. The fixing clip according to claim 18, wherein the at least one fastening extension is formed by a plate section of the base plate, each plate section being arranged in side-by-side relation with other sections of the base plate.

21. The fixing clip according to claim 18, wherein the base portion includes at least two spaced apart fastening extensions.

22. The fixing clip according to claim 18, wherein at least one fastening extension includes a fastening fixture through which a fastener can be received or attached to fasten the fixing clip to the support structure.

23. The fixing clip according to claim 22, wherein the fastening fixture is an aperture, slot or through hole.

24. The fixing clip according to claim 1, wherein the connection arrangement includes a pair of spaced apart fixing clipping recesses positioned to receive a respective furring channel flange therein in order to connect the furring channel to the fixing clip.
